(19) United States
(12) Patent Application Publication
(10) Pub. No.: US 2025/0256535 A1
(43) Pub. Date: Aug. 14, 2025

(54) SYSTEM AND METHOD FOR MONITORING TIRES

(71) Applicant: MESOMAT INC., Hamilton (CA)

(72) Inventors: Karoly J.T. Dalnoki-Veress, Hamilton (CA); Clare Lindsay Armstrong, Hamilton (CA); Duncan Clackdoyle, Hamilton (CA); Paul Fowler, Hamilton (CA)

(21) Appl. No.: 18/856,464

(22) PCT Filed: Apr. 14, 2023
(86) PCT No.: PCT/IB2023/053852

§ 371 Date: Oct. 11, 2024

Related U.S. Application Data
(60) Provisional application No. 63/330,920, filed on Apr. 14, 2022.

(51) Int. Cl. B60C 23/06; B60C 23/04

(52) U.S. Cl. CPC B60C 23/064; B60C 23/0476; B60C 2200/04

(57) ABSTRACT

An example sensing arrangement for a tire includes: a substrate configured to couple the sensing arrangement to an inner side of the tire; a deformation sensor supported by the substrate and configured to collect deformation data representing deformation at the inner side of the tire; a control module configured to transmit the deformation data collected by the deformation sensor to a recipient device.

### CROSS REFERENCE TO RELATED APPLICATIONS

The present application claims priority from U.S. Application No. 63/330,920, filed on Apr. 14, 2022, the contents of which are incorporated herein by reference.

### FIELD

The specification relates generally to vehicular monitoring systems, and more particularly to a system and method for monitoring tires on vehicles.

### BACKGROUND

Tires can be found in many applications, particularly to transport people and goods in vehicles. Tracking tire performance can help increase safety and reduce the risk of overuse of worn tires. However, existing tire monitoring systems monitor a limited number of factors, which provides limited capability for tracking tire performance.

### SUMMARY

According to an aspect of the present specification an example sensing arrangement for a tire includes: a substrate configured to couple the sensing arrangement to an inner side of the tire; a deformation sensor supported by the substrate and configured to collect deformation data representing deformation at the inner side of the tire; a control module configured to transmit the deformation data collected by the deformation sensor to a recipient device.

According to another aspect of the present specification, an example tire monitoring system includes: a set of sensing arrangements, each sensing arrangement configured to couple to an inner side of one of the tires in the set to collect deformation data representing deformation at the inner side of the tire; a monitoring hub configured to aggregate the deformation data from each sensing arrangement in the set and transmit the aggregated deformation data to a server.

According to another aspect of the present specification, an example server includes: a memory; a communications interface; and a processor interconnected with the memory and the communications interface, the processor configured to: obtain deformation data representing deformation of the tire over a series of rotations; detect a repeating pattern in the deformation data; determine, based on the repeating pattern, a contact angle of the tire; determine a contact length as a product of the contact angle and a radius of the tire; and determine a working condition assessment of the tire based on the contact length.

According to another aspect of the present specification, an example method includes: obtaining deformation data representing deformation of the tire over a series of rotations; detecting a repeating pattern in the deformation data; determining, based on the repeating pattern, a contact angle of the tire; determining a contact length as a product of the contact angle and a radius of the tire; and determining a working condition assessment of the tire based on the contact length.

### BRIEF DESCRIPTION OF DRAWINGS

Implementations are described with reference to the following figures, in which:

FIG. 1 depicts a schematic diagram of an example tire monitoring system in accordance with the present disclosure.

FIG. 2A depicts a schematic diagram of the sensing arrangement for monitoring tires of FIG. 1.

FIG. 2B depicts a block diagram of certain internal components of the sensing arrangement of FIG. 1.

FIG. 3 depicts a block diagram of certain internal components of the server of FIG. 1.

FIG. 4 depicts a flowchart of an example method of monitoring tires in accordance with the present disclosure.

FIG. 5 depicts a flowchart of an example method of obtaining vehicle data for block 405 of the method of FIG. 4.

FIGS. 6A and 6B depict a schematic diagram of a tire in rotation and a corresponding deformation pulse, respectively.

FIG. 7 depicts a schematic diagram of example deformation data obtained in the tire monitoring system of FIG. 1.

FIG. 8 depicts a flowchart of an example method of determining tire performance at block 435 of the method of FIG. 4.

FIG. 9 depicts a flowchart of an example method of determining vehicle performance at block 435 of the method of FIG. 4.

FIGS. 10A and 10B depict schematic diagrams of further example deformation data obtained in the tire monitoring system of FIG. 1.

### DETAILED DESCRIPTION

Typical tire monitoring systems often measure tire pressure and may sometimes additionally measure tire temperature. However, the pressure and temperature measurements typically occur at the valve stem, resulting in a temperature representative of the air cavity in the tire rather than the rubber material of the tire itself. Accordingly, such measurements are less valuable for predictive monitoring as the actual temperature of the tire, since the difference in temperature between the air cavity and the rubber material is inconsistent. Further, the pressure of the tire alone provides limited insights into tire performance. Another factor for monitoring tire performance is the length of the patch of tire which is in contact with the surface on which the tire is travelling, or the contact length. Typically, the contact length is a difficult factor to measure, and cannot be derived based on temperature and pressure measurements obtained in existing systems.

In accordance with the present disclosure, a system and method for determining tire performance includes obtaining deformation data representing the deformation of the tire over a series of rotations. The deformation data may be analyzed to detect a repeating pattern, determine a contact angle from the repeating pattern, and determine a contact length from the contact angle. The contact length may then be analyzed in context of the temperature and pressure to determine a working condition assessment of the tire.

Additionally, the configuration of the sensing arrangement used to obtain the deformation data allows for placement of the temperature sensor adjacent to the inner side of the tire, and the tire material itself, such that the temperature measurements obtained from the temperature sensor are representative of the tire itself, rather than the air cavity. Accordingly, the temperature data, pressure data and deformation data allow for a more robust assessment of the working conditions of the tire. Further, the tire data may be accumulated and correlated with data for other tires on the same vehicle to obtain vehicle data, as well as correlated to historical data to determine tire performance over time.

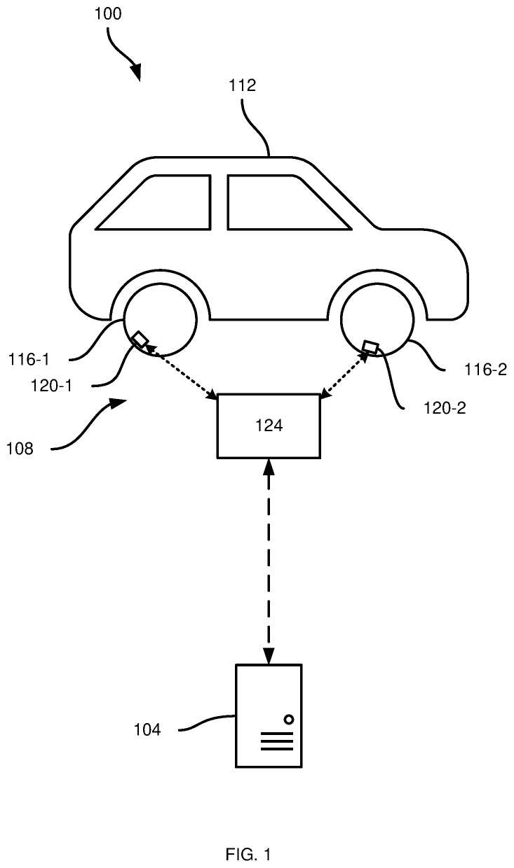

FIG. 1 depicts a system 100 for monitoring tires to determine tire performance and wear. The system 100 includes a server 104 interconnected with a tire monitoring system 108. The tire monitoring system 108 is configured to monitor a vehicle 112, and more particularly, a set of tires, of which two tires 116-1 and 116-2 (referred to generically as a tire 116 and collectively as tires 116 or the set of tires 116; this nomenclature is used elsewhere herein), are shown. The vehicle 112 may be an automotive vehicle, such as a car, a truck, or the like, or may include other types of vehicles, such as a wagon, a trailer, a plane, a wheelbarrow, or other vehicle including load-bearing tires for monitoring the performance of said tires. Accordingly, the vehicle 112 may include four tires 116, or more tires (e.g., eighteen tires on a semi-trailer truck) or fewer tires (e.g., one tire on a wheelbarrow) in other examples.

The server 104 is generally configured to analyze vehicle data including data representing the environmental conditions experienced by the tires 116. The server 104 may use the vehicle data to determine tire performance, including detecting wear and potential issues with the tires, load balancing, and the like. The server 104 may be any suitable server environment, including a series of cooperating servers, one or more cloud-based servers, and the like. The internal components of the server 104 will be described in greater detail below.

The tire monitoring system 108 is generally configured to collect the vehicle data and transmit the vehicle data to the server. Specifically, the tire monitoring system 108 includes a set of sensing arrangements, of which two sensing arrangements 120-1 and 120-2 are depicted, and may further include a monitoring hub 124.

Each of the sensing arrangements 120 is coupled to one of the tires 116 of the vehicle 112. Preferably, the tire monitoring system 108 includes one sensing arrangement 120 per tire 116 of the vehicle 112. Accordingly, if the vehicle 112 is a car having four tires 116 (of which only two are depicted), then the tire monitoring system 108 may also include four sensing arrangements 120 (of which only two are depicted). The sensing arrangements 120 are preferably coupled to an inner side of the tires 116 and are configured to measure tire data, including deformation data representing deformations experienced by the tires 116 (e.g., at portion of the tires 116 in contact with a surface on which the vehicle 112 is moving), temperature data representing the temperatures of the tires 116, pressure data representing the air pressure within the tire cavities, and the like.

The sensing arrangements 120 may be in communication with the monitoring hub 124. Preferably, the monitoring hub 124 may be local to the vehicle 112 to allow short-range wireless communications between the sensing arrangements 120 and the monitoring hub 124. For example, the sensing arrangements 120 and the monitoring hub 124 may be in communication via a Bluetooth Low Energy (BLE) protocol or similar.

The monitoring hub 124 is generally configured to aggregate data from each of the sensing arrangements 120 to form vehicle data for the vehicle 112. The monitoring hub 124 may therefore include a suitable processor or controller, a memory storing computer-readable instructions, and a communications interface to enable the functionality described herein. For example, the monitoring hub 124 may include a short-range wireless communications interface to communicate and receive tire data from the sensing arrangements 120.

The monitoring hub 124 may further be in communication with the server 104 via one or more communication links, including wired and/or wireless communication links, combinations thereof, links which may traverse one or more networks, including local area networks, wide-area networks, the internet, and the like. Accordingly, the tire monitoring system 108 may be in communication with the server 104 via the monitoring hub 124 to send the vehicle data to the server 104.

In some examples, the monitoring hub 124 may further include input and/or output devices, such as a display, speakers, a keyboard, a touch display, or the like, to allow an operator of the vehicle 112 to interact with the monitoring hub 124. For example, the monitoring hub 124 may display the tire data collected by each of the sensing arrangements 120, or analysis results from the server 104 based on the collected tire data, for example indicating the performance of each tire 116 (e.g., indicating that the tires 116 are in good operating condition or indicating detected risk and/or hazard conditions) and/or the vehicle performance. The monitoring hub 124 may further allow the operator of the vehicle 112 to connect one or more devices (e.g., a mobile device or the like) to allow the operator to receive updates on the determined performance.

Accordingly, in operation, each of the sensing arrangements 120 may collect tire data about conditions experienced by its respective tire 116 over a series of rotations. The tire data may include deformation data, temperature data, pressure, data, and the like. Each of the sensing arrangements 120 may send the tire data to the monitoring hub 124 over a short range wireless network. The monitoring hub 124 may aggregate the tire data of each of the tires 116 of the vehicle 112 to form vehicle data (e.g., associated with the vehicle 112). The vehicle data, in turn, may be sent by the monitoring hub 124 to the server 104 for further analysis.

The server 104 may analyze the vehicle data captured by the sensor arrangements 120 to determine tire performance. For example, the server 104 may use the deformation data to determine a contact length for each tire 116. The contact length, together with the pressure data, for example, may allow the server 104 to determine the load on each tire 116. The server 104 may further correlate the load on each of the tires 116 of the vehicle 112 to determine the load distribution between the tires 116 of the vehicle 112. The server 104 may aggregate the tire performance factors to determine a working condition assessment of each individual tire, as well as vehicle performance factors to determine a working condition assessment of the vehicle.

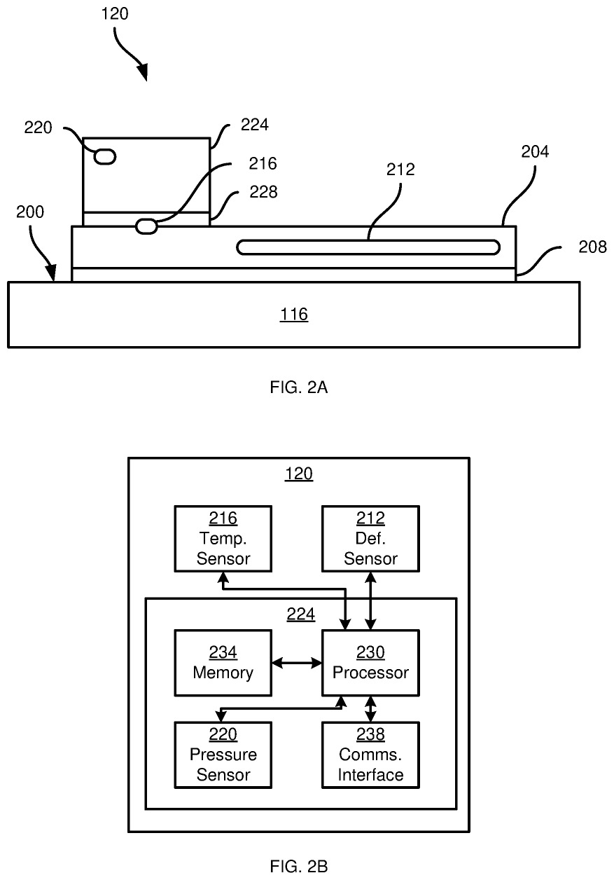

Turning now to FIG. 2A, a schematic diagram of the sensing arrangement 120 according to an example. In particular, the sensing arrangement 120 is depicted as being coupled to one of the tires 116, and more particularly, to an inner side 200 of the tire 116. In particular, the tire 116 may be mounted on a rim (not shown) to define a cavity between the tire 116 and the rim. The cavity may be inflated with air to pressurize the tire 116 to allow the tire 116 to function to support the vehicle 112. Accordingly, the sensing arrangement 120 may be applied within the cavity on the inner side 200 of the tire 116. Preferably, the sensing arrangement 120 may be applied at a center line of the width of the tire 116. As presently depicted, the tire 116 is substantially flat; it will be understood that the tire 116 may be curved, such that the inner side 200 is concave relative to a center of the tire 116.

The sensing arrangement 120 includes a substrate 204 configured to support the components of the sensing arrangement 120 and to couple the sensing arrangement 120 to the inner side 200 of the tire 116. The substrate 204 may preferably be flexible to conform to the curvature of the tire 116.

The sensing arrangement 120, and more particularly the substrate 204, may further include an adhesive layer 208 configured to adhere the substrate 204 to the inner side 200 of the tire 116. The adhesive layer 208 may be any suitable adhesive material, including pressure-sensitive adhesives, contact adhesives, and the like or other suitable manners of adhering the substrate 204 to the inner side 200 of the tire 116, such as by suction cup, including micro-suction cups, and the like. The adhesive layer 208 may be selected based on its compatibility with the rubber or other material of the tire 116 and/or an inner layer of the tire 116 which forms the inner side 200.

The sensing arrangement 120 further includes a set of sensors, including a deformation sensor 212, a temperature sensor 216, and a pressure sensor 220. In other examples, the sensing arrangement 120 may include multiple deformation sensors 212, multiple temperature sensors 216, multiple pressure sensors 220, other types of sensors or combinations of sensors, and the like.

The deformation sensor 212 is supported by the substrate 204, and in the present example, is embedded within the substrate 204, for example to protect the deformation sensor 212 from damage during installation of the sensor arrangement 120. The deformation sensor 212 is generally configured to detect deformation over the length of the deformation sensor 212. Accordingly, when the sensor arrangement 120 is installed on the inner side 200 of the tire 116, the deformation sensor 212 detects deformation at the inner side 200 of the tire 116. Preferably, the deformation sensor 212 may have a length exceeding a length of a tread pattern of the tire. That is, the deformation sensor 212 is preferably sized such that deformations detected over the length of the deformation sensor 212 pertain to the tire 116 rather than being affected more local deformations due to tread movements.

For example, the deformation sensor 212 may be a strain sensor configured to measure strain at the inner side 200 of the tire 116. The strain sensor may include, for example, nanomaterial-coated fibers or a yarn of nanomaterial-coated fibers as described in U.S. patent application Ser. No. 16/977,711, the contents of which are incorporated herein by reference. In other examples, the deformation sensor 212 may be a force sensor, a pressure sensor, or another sensor configured to monitor a change in curvature of the tire 116 as the deformation sensor 212 passes through the contact length of the tire 116 as further described below.

The temperature sensor 216 is supported by the substrate 204 adjacent to the inner side 200 of the tire 116. That is, the temperature sensor 216 may be supported by the substrate 204 within a threshold distance of the inner side 200 of the tire 116. The threshold distance may be selected according to an operational range of the temperature sensor 216. Thus, the temperature sensor 216 may be supported by the substrate 204 at a distance from the inner side 200 of the tire 116 which is within its operational range, to allow the temperature sensor 216 to detect the temperature of the inner side 200 of the tire 116. Accordingly, the temperature sensor 216 is configured to measure the temperature of the tire 116 itself, rather than the temperature of the air cavity within the tire 116.

Thus, in the present example, the temperature sensor 216 is at least partially embedded in the substrate 204 to position the temperature sensor 216 adjacent to the inner side 200 of the tire 116 when the sensing arrangement 120 is installed on the tire 116.

The sensing arrangement 120 further includes a pressure sensor 220 supported by the substrate 204 and generally configured to detect an air pressure of the air cavity within the tire 116. That is, the pressure sensor 220 determines an internal tire pressure for the tire 116. Accordingly, the pressure sensor 220 may be supported by the substrate 204 away from the inner side 200 of the tire 116 to position the pressure sensor 220 closer to a center of the air cavity of the tire 116.

The sensing arrangement 120 further includes an electronics module 224. In the present example, the pressure sensor 220 is embedded within the electronics module 224, for example on a printed circuit board within the electronics module 224. The electronics module 224 is generally configured to manage raw data collected by the set of sensors and to communicate the raw data to a recipient device. In some examples, the electronics module 224 may further be configured to filter data, perform calculations, and the like to control and reduce the amount of data communicated to the recipient device.

The electronics module 224 may preferably include a housing, such as an enclosure, in which the electronics of the sensing arrangement 120 are housed, to protect the electronics. Preferably, the electronics module 224 may be supported on the substrate 204 and set away from the substrate 204 by a vibration damping portion 228. The vibration damping portion 228 may be a flexible material (e.g., rubber or the like) to dampen transmission of vibrations or other shocks experienced by the tire 116 to the electronics module 224. In some examples, the vibration damping portion 228 may support the entirety of the electronics module 224, including the housing and the electronics housed therein, away from the inner side 200 of the tire 116, while in other examples, the vibration damping portion 228 may be enclosed in the housing of the electronics module 224 to isolate the electronic components within the electronics module 224 from vibrations experienced by the substrate 204 and transmitted through the housing.

FIG. 2B depicts a block diagram of certain internal components of the sensing arrangement 120, and in particular, of the electronics module 224. The electronics module 224 may house a processor 230, interconnected with a memory 234 and a communications interface 238.

The processor 230 may include a microcontroller, a microprocessor, a processing core, a field-programmable gate array (FPGA), an application-specific integrated circuit (ASIC), or other suitable control unit capable of executing instructions. The processor 300 may include multiple cooperating processors.

The memory 234 may include a combination of volatile (e.g., Random Access Memory or RAM) and non-volatile memory (e.g., read-only memory or ROM, Electrically Erasable Programmable Read Only Memory or EEPROM, flash memory). All or some of the memory 234 may be integrated with the processor 230. The memory 234 may store computer readable instructions which when executed, configure the sensing arrangement 120 to perform the functionality described herein.

The communications interface 238 may be configured for wireless (e.g., Bluetooth, Wi-Fi, or other suitable communications protocols) communications and may include suitable hardware (e.g., transmitters, receivers, network interface controllers, and the like) to allow the sensing arrangement 120 to communicate with other computing devices, such as the monitoring hub 124. Accordingly, the communications interface 238 may preferably be configured for short range wireless communications. In other examples, the sensing arrangements 120 may communicate with the server 104 directly, and hence may be configured for long range wireless communications. For example, the communications interface 238 may be configured for low power, wide area network communications.

The processor 230 is interconnected with the memory 234 and the communications interface 238, as well as with each of the sensors in the sensor suite, including the deformation sensor 212, the temperature sensor 216 and the pressure sensor 220. That is, the processor 230 may, in some examples, control the data collection operation by each of the sensors 212, 216, and 220, as well as obtaining and processing the data collected by each of the sensors 212, 216, and 220.

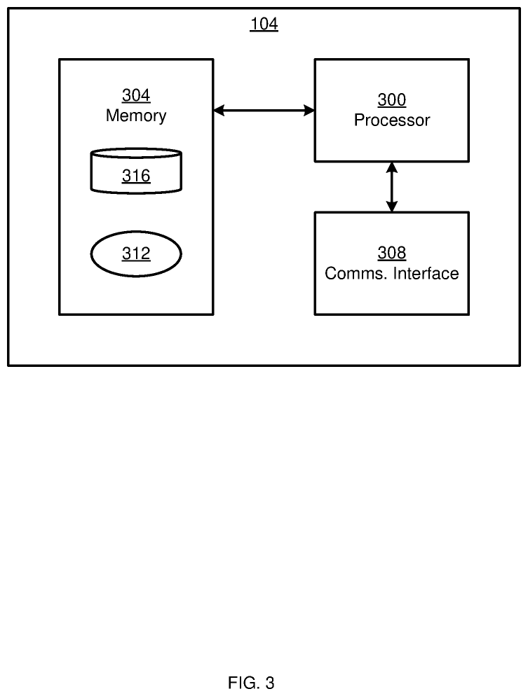

Turning now to FIG. 3, certain internal components of the server 104 are depicted in greater detail. The server 104 includes a processor 300, a memory 304 and a communications interface 308.

The processor 300 may include a central processing unit (CPU), a microcontroller, a microprocessor, a processing core, a field-programmable gate array (FPGA), or similar. The processor 300 may include multiple cooperating processors. The processor 300 may cooperate with the memory 304 to realize the functionality described herein.

The memory 304 may include a combination of volatile (e.g., Random Access Memory or RAM) and non-volatile memory (e.g., read-only memory or ROM, Electrically Erasable Programmable Read Only Memory or EEPROM, flash memory). All or some of the memory 304 may be integrated with the processor 300. The memory stores applications, each including a plurality of computer-readable instructions executable by the processor 300. The execution of the instructions by the processor 300 configures the server 104 to perform the actions discussed herein. In particular, the applications stored in the memory 304 include a tire monitoring application 312. When executed by the processor 300, the application 312 configures the processor 300 to perform various functions discussed below in greater detail and related to the tire monitoring operation of the server 104. The application 312 may also be implemented as a suite of distinct applications. Further, Some or all of the functionality of the application 312 may be implemented as dedicated hardware components, such as one or more FPGAs or application-specific integrated circuits (ASICs).

The memory 304 also stores a repository 316 storing rules and data for the tire monitoring operation. For example, the repository 316 may store associations between tires 116 and vehicles 112, associations between vehicles 112, user accounts (e.g., to subscribe to performance analysis results) and user devices (e.g., to provision analysis results to the user), historical data for each of the tires 116 and each of the vehicles 112, and the like.

The server 104 further includes the communications interface 308 interconnected with the processor 300. The communications interface 308 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the server 104 to communicate with other computing devices. The specific components of the communications interface 308 are selected based on the types of communication links that the server 104 communicates over.

The server 104 may further include one or more input and/or output devices (not shown). The input devices may include one or more buttons, keypads, touch-sensitive display screen, mice, or the like for receiving input from an operator. The output devices may include one or more display screens, monitors, speakers, sound generators, vibrators, or the like for providing output or feedback to an operator.

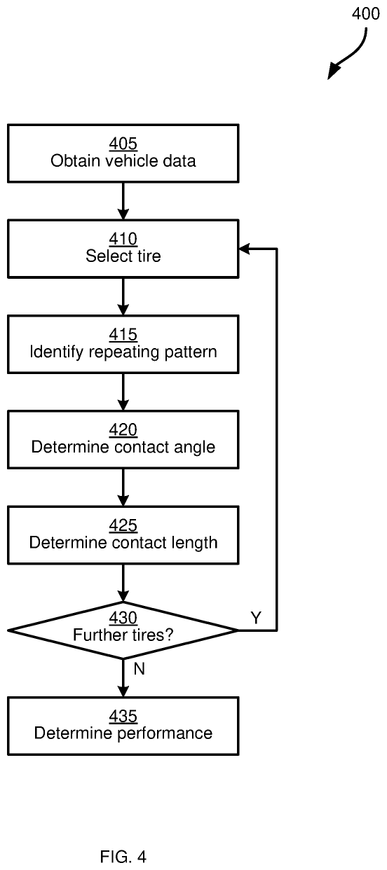

Turning now to FIG. 4, the functionality implemented by the server 104 will be discussed in greater detail. FIG. 4 illustrates a method 400 of monitoring tires. The method 400 will be discussed in conjunction with its performance in the system 100 and in particular by the server 104 via execution of the application 312. In particular, the method 400 will be described with reference to the components of FIGS. 1 to 3. In other examples, the method 400 may be performed, in whole or in part, by other suitable devices or systems, such as the monitoring hub 124, or the processor 230 of the sensing arrangement 120.

At block 405, the server 104 obtains vehicle data data, including tire data corresponding to each of the tires 116 of the vehicle 112. The tire data corresponding to each of the tires 116 may include deformation data representing deformation of the tire 116 over a series of rotations of the tire 116. In some examples, the tire data may further include temperature data and pressure data for the tire 116.

The tire data for each tire 116 may be collected at the tire 116 by the corresponding sensing arrangement 120 coupled to the tire. Accordingly, the deformation data may be collected at the tire 116 by the deformation sensor 212 located at the inner side 200 of the tire 116. In particular, the deformation sensor 212 may be a strain sensor configured to measure strain at the inner side 200 of the tire 116. The temperature data may be collected by the temperature sensor 216 located at the inner side 200 of the tire 116 and in particular, located adjacent to the inner side 200 of the tire 116 to measure the temperature of the tire 116 itself rather than the air cavity of the tire. Further, the pressure data may be collected by the pressure sensor 220.

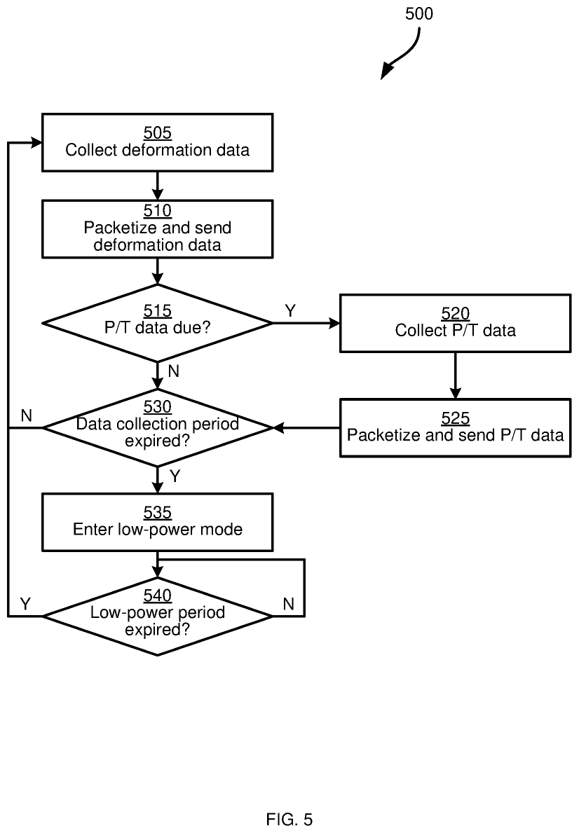

For example, referring to FIG. 5, an example method 500 of collecting tire data is depicted. The method 500 may be performed, for example, by the sensing arrangement 120, or other suitable devices and/or systems.

At block 505, the sensing arrangement 120, and more particularly, the deformation sensor 212, collects deformation data. For example, the deformation sensor 212 may be a strain sensor which measures electrical resistance through the strain sensor to determine strain. That is, the electrical resistance measurements may vary according to (e.g., proportionally or inversely proportionally) to the strain experienced by the strain sensor.

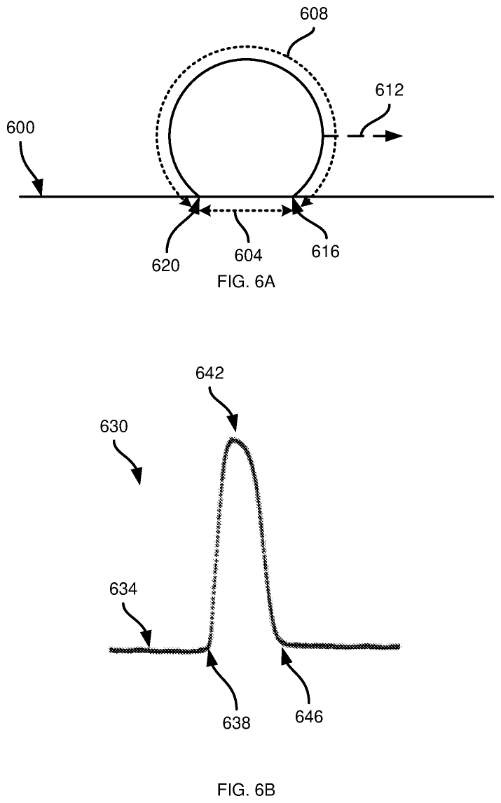

For example, FIG. 6A depicts an example schematic diagram of the tire 116 supported on a surface 600. On the surface 600, the tire 116 deforms along a contact length 604 to conform to the surface 600, with a free length 608 is disposed away from the surface 600. As the tire 116 rotates on the surface 600, for example moving in a direction 612, the deformation sensor 212 effectively rotates in a clockwise direction along the perimeter of the tire 116.

Accordingly, when the deformation sensor 212 is disposed along the free length 608, the tire 116 is in its neutral shape, and hence the deformation sensor 212 may detect a baseline level of deformation. When the deformation sensor 212 is disposed at an entry point 616 of the contact length 604, the local region of the tire 116 about the deformation sensor 212 shifts from its neutral shape to a deformed shape to accommodate the surface 600. Accordingly, at the entry point 616, the deformation sensor 212 detects a first deformation shift. As the deformation sensor 212 moves along the contact length 604, the local region of the tire 116 about the deformation sensor 212 may deform further to continue accommodating the surface 600. Accordingly, the deformation sensor 212 may detect a deformation peak over the contact length 604. When the deformation sensor 212 is disposed at an exit point 620 of the contact length 604, the local region of the tire 116 about the deformation sensor 212 shifts from the deformed shape back to its neutral shape upon moving away from the surface 600. Accordingly, the deformation sensor 212 may detect a second deformation shift at the exit point 620.

Thus, for example, referring to FIG. 6B, an example pulse 630 defined by the deformation data is depicted. Specifically, the pulse 630 depicts strain experienced by the tire 116 over the course of a single rotation. The tire 116 experiences a uniform strain while the tire 116 is in its neutral shape and curvature over the free length 608, forming a baseline 634 of the pulse 630. As the deformation sensor 212 moves to the entry point 616, the curvature of the local region of the tire 116 about the deformation sensor 212 increases, thereby decreasing the strain. Accordingly, the pulse 630 may exhibit a first deformation shift 638 (e.g., a decrease in strain) when the location of the deformation sensor 212 corresponds to the entry point 616. As the deformation sensor 212 moves along the contact length 604, the curvature of the local region of the tire 116 about the deformation sensor 212 decreases, thereby increasing the strain. Accordingly, the pulse 630 may exhibit a deformation peak 642 over the contact length 604. Finally, as the deformation sensor 212 moves to the exit point 620, the curvature of the local region of the tire 116 about the deformation sensor 212 again increases, thereby decreasing the strain. Accordingly, the pulse 630 may exhibit a second deformation shift 646 (e.g., a decrease in strain) when the location of the deformation sensor 212 corresponds to the exit point 620.

Preferably, to accurately detect the first and second deformation shifts 638 and 646, as well as the deformation peak 642, the deformation sensor 212 may collect at least ten data points over the deformation peak. Accordingly, based on typical car tire speeds and contact angles (i.e., the angle which subtends the contact length 604), the deformation sensor 212 may preferably collect measurements at a frequency of at least about 3600 Hz. According to an example, the deformation sensor 212 may implement a roughly 4200 Hz measurement frequency. In other examples, the measurement frequency may be higher, for example for higher speed applications.

Returning to FIG. 5, at block 510, the sensing arrangement 120 packetizes deformation data. That is, in order to send the data to a recipient device, the deformation data collected at block 505 may be condensed by reducing each measurement to a 2-byte value. Further, since the deformation sensor 212 is configured to collect data at a constant frequency, only two timestamps may be reported in the packetized data (e.g., one corresponding to an initial resistance or deformation measurement and one corresponding to a final resistance or deformation measurement). In some examples, the sensing arrangement 120 may perform further filtering operations and/or other types of data compression and the like prior to sending the data to the recipient device.

After condensing and packetizing the deformation data, the sensing arrangement 120 sends the data packet to a recipient device. According to a preferred example, the recipient device is the monitoring hub 124, to allow the sensing arrangement 120 to employ a short-range, low energy communications protocol, such as BLE.

At block 515, the sensing arrangement 120 determines whether pressure and/or temperature data measurement is due. In particular, since pressure and temperature do not change on the same timescales associated with the rotation frequency of a tire, the sensing arrangement 120 may track a separate timer for sending pressure and temperature data at an appropriate predefined frequency (e.g., once per second, 3 seconds, etc.).

If, at block 515, the determination is affirmative, that is, that temperature and pressure are due to be collected, then the sensing arrangement 120 proceeds to block 520. At block 520, the sensing arrangement 120, and more particularly, the temperature sensor 216 and the pressure sensor 220, collect temperature and pressure measurements, respectively.

In particular, the temperature sensor 216 detects the temperature within its operational radius, and hence may particularly detect the temperature of the inner side 200 of the tire 116. That is, the temperature measurements collected by the temperature sensor 216 may more closely correspond to temperatures experienced by the tire 116 itself, rather than temperatures generated within the air cavity of the tire 116. The pressure sensor 220, on the other hand, may detect the air pressure of the air cavity of the tire 116.

At block 525, the sensing arrangement 120 packetizes the temperature and pressure data. For example, the temperature and pressure measurements may similarly be reduced to a 2-byte value. In some examples, the packet containing temperature and pressure measurements may further include a battery voltage measurement to allow the battery state to be monitored. Further, in some examples, the packet containing temperature and pressure measurements may be combined with deformation data resistance measurements. In other examples, the packet may contain only temperature and pressure data, and the packet may be inserted into the queue to be sent amongst the deformation data packets. In some examples, the sensing arrangement 120 may perform further filtering operations and/or other types of data compression and the like prior to sending the data to the recipient device.

After condensing and packetizing the temperature and pressure data, the sensing arrangement 120 sends the data packet to the recipient device.

After sending the packetized temperature and pressure data at block 525, or if no temperature and pressure measurements are due to be acquired (i.e., a negative determination at block 515), the sensing arrangement 120 proceeds to block 530. At block 530, the sensing arrangement 120 determines if a data collection period has expired.

In order to achieve power efficient operation, the sensing arrangement 120 may operate intermittently. That is, the sensing arrangement 120 may operate in a low-power state for a predefined low-power period and may operate in a data collection mode for a predefined data collection period. In the low-power state, the sensing arrangement 120 may be in a “sleep” state, in which it is not measuring tire data or transmitting data. In the data collection mode, the sensing arrangement 120 may operate to collect tire data and transmit said data, in accordance with blocks 505 to 525 described above. For example, the predefined low-power period may be about 60 seconds, and the data collection period may be about 7 seconds. In other examples, the length of the low-power period and the data collection period may be adjusted to optimize battery life and to acquire sufficient data for analysis.

Accordingly, the sensing arrangement 120 may track the data collection period and check, at block 530, whether the data collection period has expired. If the data collection period has not yet expired, the sensing arrangement 120 returns to block 505 to continue collecting further deformation data.

If, at block 530, the data collection period has expired, the sensing arrangement 120 proceeds to block 535. At block 535, the sensing arrangement 120 enters the low-power or sleep state to reduce energy and battery consumption. The sensing arrangement 120 may further initiate a timer to track the low-power period and reset a timer tracking the data collection period.

At block 540, the sensing arrangement 120 determines whether the low-power period has expired. If the low-power period has not expired, the sensing arrangement 120 is maintained in its low-power state.

If the low-power period has expired, then the sensing arrangement 120 transitions to the data collection mode and returns to block 505 to collect deformation data. Upon moving to the data collection mode, the sensing arrangement 120 may reset the timer for the low-power period and initiate a timer to track the data collection period.

Accordingly, the sensing arrangement 120 may regularly send deformation data, as well as temperature and pressure data, to a recipient device. In the present example, the recipient device is the monitoring hub 124. The monitoring hub 124 may therefore receive tire data from each of the sensing arrangements 120 corresponding to each of the tires 116 of the vehicle 112.

The monitoring hub 124 may aggregate the tire data from each of the tires 116 to form vehicle data for the vehicle 112. For example, the monitoring hub 124 may correlate each set of tire data with a vehicle identifier or the like. Correlation of the tire data experienced by each of the tires 116 of the vehicle 112 may allow subsequent analysis of overall vehicle performance and suggestions to improve vehicle performance, for example based on load distribution, and the like. Further, in some examples, the monitoring hub 124 may correlate each set of tire data with a trip identifier, for example to identify separate trips which the vehicle 112 makes (i.e., where each trip may be distinguished by an extended period in which the vehicle 112 and the tires 116 are stationary).

In some examples, the analysis of performances of the vehicle 112 and the tires 116 may be performed by the monitoring hub 124 itself, based on the tire data from each of the tires 116. In other examples, the monitoring hub 124 may aggregate the tire data and transmit the tire data to the server 104. In still further examples, the sensing arrangement 120 may bypass the monitoring hub 124 and send the tire data directly to the server 104 as the recipient device.

Returning to FIG. 4, at block 410, after obtaining the deformation data, and temperature data and pressure data as applicable, the server 104 selects one of the tires 116 to analyze. In particular, as the vehicle 112 and the tires 116 rotate to move the vehicle 112, the server 104 may expect that each given tire 116 undergoes substantially equal forces on each rotation, and hence the deformation experienced by the tire 116 in any given rotation may be substantially equal to the deformation experienced in any other rotation. Accordingly, each rotation of the tire 116 may generate substantially the same pattern in the deformation data. Accordingly, the server 104 may select one of the tires 116, extract the corresponding deformation data from the vehicle data, and analyze the deformation data for the selected tire 116.

At block 415, the server 104 identifies a repeating pattern in the deformation data for the tire selected at block 410. For example, the deformation data may include a series of deformation pulses, such as the pulse 630 depicted in FIG. 6B, each corresponding to a rotation of the tire 116 as the vehicle 112 travels on a surface.

For example, since the tires 116 may experience substantially the same deformation over a given rotation, the server 104 may detect the repeating pattern based on similarity of portions of the deformation data to a representative model pattern (e.g., based on computer-simulated or ideal conditions).

In other examples, the server 104 may first identify the baseline for the deformation data (i.e., corresponding to the deformation and/or strain experienced by the tire 116 over its free length 604. The server 104 may then detect deformation pulses, for example by identifying peaks (e.g., local maxima) in the deformation data. The server 104 may additionally verify that the identified pulses correspond to the repeating pattern, for example, based on a magnitude of the pulse being at least a certain threshold, within a threshold percentage or standard deviation of the average magnitude of other identified pulses, or similar. In other examples, other manners of detecting the repeating pattern are also contemplated.

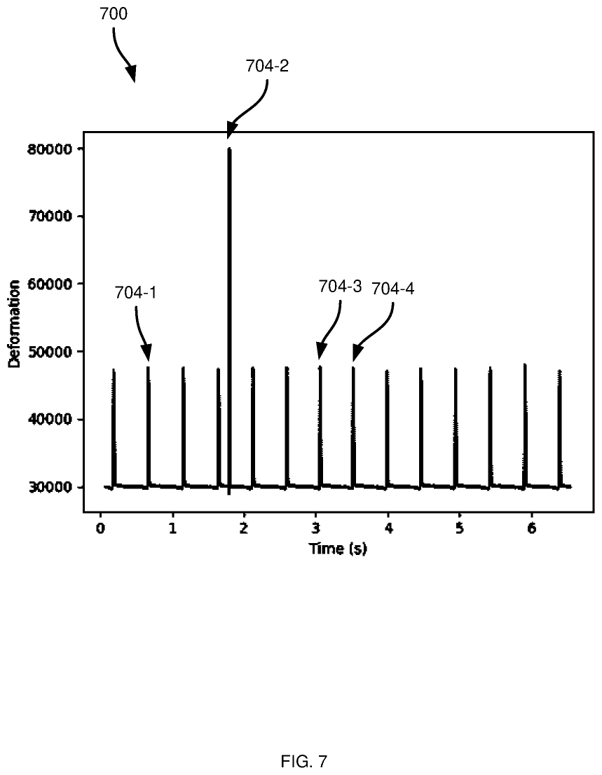

For example, referring to FIG. 7, example deformation data 700 is depicted. The deformation data 700 includes a series of deformation pulses, including pulses 704-1, 704-2, 704-3, and 704-4. Upon analysis, the server 104 may identify the pulses 704-1, 704-3, and 704-4 as forming a repeating pattern, for example, as having a magnitude within a threshold similarity as one another, and/or as having similar proportions. In contrast, the server 104 may determine that the pulse 704-2 is not part of the repeating pattern based in its magnitude.

Returning to FIG. 4, at block 420, the server 104 uses the repeating pattern to determine a contact angle of the tire 116. The contact angle for the tire 116 is the angle which subtends the contact length of the tire 116. For example, referring again to FIG. 5, the contact angle for the tire 116 is given by the angle α. The contact angle α may be computed according to Equation (1):

$$α = 2 π \cdot {t}_{c} / {t}_{r} \qquad ( 1 )$$

In Equation (1), t_{c} represents the contact time for the deformation sensor 212—that is, t_{c} represents the time for the sensor 212 to pass through the contact length 604 during a rotation—and tᵣ represents the revolution time for the deformation sensor 212 to complete a full revolution about the center of the tire 116—that is, the time for the tire 116 to complete a full rotation.

Accordingly, the server 104 may analyze the deformation data to determine the contact time t_{c} and the revolution time tᵣ for the deformation sensor 212. In particular, with reference to FIGS. 6A and 6B, the time at which the deformation sensor 212 enters the contact length 604 at the entry point 616 corresponds to the first deformation shift 638, and the time at which the deformation sensor 212 exits the contact length 604 at the exit point 620 corresponds to the second deformation shift 646. Accordingly, the contact time t_{c} may be computed based on the width of the deformation peak 642 of the pulse 630.

For example, the width of the deformation peak 642 may be determined based on a full-width-half-maximum (i.e., compute the width between the two points corresponding to half the maximum height of the deformation peak 642). In other examples, the width of the deformation peak 642 may be determined by identifying inflection points in the pulse 630 (i.e., the first and second deformation shifts 638 and 646), based on a rise above a predefined threshold, by integrating under the deformation peak 642, or other suitable methods.

The revolution time tᵣ corresponds to the time for the deformation sensor 212 to revolve from a given position, about the center of the tire 116, and return to the same position. Since the position of the deformation sensor 212 along the free length 608 may produce approximately equivalent deformation values in the deformation data, the server 104 may use a position along the contact length 604 to track sequential equivalent positions of the deformation sensor 212. For example, the server 104 may identify sequential instances of the first deformation shift 638 to detect sequential instances of the deformation sensor 212 at the entry point 616. At a constant rotation (i.e., between sequential pulses 630), the distance between sequential instances the first deformation shift 638 may be substantially equivalent to the distance between sequential instances of the deformation peak 642. Accordingly, the server 104 may approximate the revolution time tᵣ based on the distance between sequential peaks.

For example, referring to FIG. 7, the pulses 704-3 and 704-4 are sequential, and hence the server 104 may identify the deformation peaks of each of the pulses 704-3 and 704-4 (e.g., by identifying a global or local maximum in the respective pulse 704) and use the distance between each of the detected deformation peaks as the revolution time tᵣ.

After determining both the contact time and the revolution time, the server 104 applies Equation (1) to obtain the contact angle α, provided in radians. In some examples, the server 104 may determine the contact angle for a single deformation pulse, for example selected as being representative of a subset of the deformation data (e.g., corresponding to a predefined time period). In other examples, the server 104 may determine the contact angle for a series of deformation pulses, for example selected as being representative of a subset of the deformation data, or for each deformation pulse in the deformation data. The server 104 may then filter outliers from the determined contact angles and compute an average contact angle.

Returning again to FIG. 4, at block 425, after determining the contact angle of the tire 116, the server 104 determines the contact length for the tire. In particular, the server 104 may determine the contact length as a product of the contact angle α, determined at block 420, and a radius of the tire 116, according to Equation (2):

$${l}_{c} = α \cdot R \qquad ( 2 )$$

In Equation (2), l_{c} is the contact length of the tire 116, and R is the radius of the tire 116. The radius R may be a predetermined value, stored in the memory 304 of the server 104, or in a memory of the monitoring hub 124 and transmitted to the server 104 with the vehicle data at block 405.

Based on the contact angle(s) determined at block 420, the server 104 may determine a single, representative contact length for the tire 116 (i.e., over a predefined period), a set of contact lengths for the tire 116—which the server 104 may subsequently average to determine an average contact length for the tire 116, e.g., over a predefined period, a contact length for the tire 116 which is based on the average contact angle for the tire 116, or similar.

At block 430, after determining the contact length for the tire 116 selected at block 410, the server 104 determines whether the vehicle includes further tires 116 for which to determine the contact length. If the determination is affirmative, then the server 104 returns to block 410 to select a further tire 116 for the vehicle 112.

If the determination at block 430 is negative, that is, the server 104 has determined the contact lengths for each of the tires 116 of the vehicle 112, then the server 104 may proceed to block 435.

At block 435, the server 104 uses the vehicle data obtained at block 405 and the contact lengths determined at block 425 to evaluate tire performance for each of the tires 116 of the vehicle 112, as well as vehicle performance of the vehicle 112 as a whole. That is, the server 104 may perform an analysis and determine a status and/or performance of each of the tires 116 individually. The server 104 may further perform an analysis and determine a status and/or performance of the tires 116 collectively, and in relation to one another. The tire and vehicle performances may result in a determination that the tires 116 and/or vehicle 112 are in good operating condition, or an identification of one or more hazard and/or risk conditions which may be communicated, for example, to an operator of the vehicle 112.

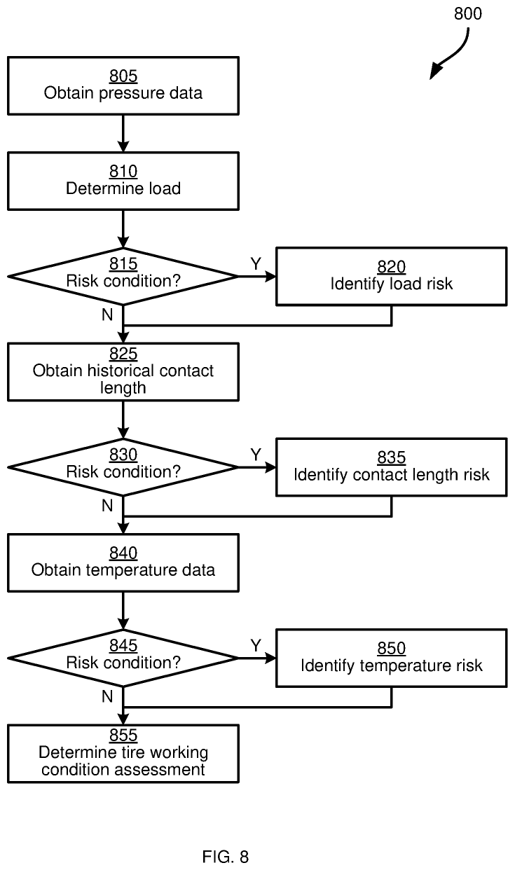

For example, referring to FIG. 8, a flowchart of an example method 800 of determining tire performance for a single tire 116 is depicted. In some examples, the operations of the method 800 may be performed in an order other than that depicted, and hence are referred to as blocks rather than steps.

At block 805, the server 104 obtains pressure data for the tire 116. The pressure data may be, for example, pressure data received as a part of the vehicle data at block 405 of the method 400. In particular, the pressure data represents the air pressure of the cavity in which the sensing arrangement 120, and more particularly, the pressure sensor 220 is disposed.

At block 810, the server 104 determines the load on the tire 116. In particular, the shape (i.e., the width and amplitude) of the deformation peak 642 are related to the pressure of the tire 116 as well as the load on the tire. For example, for a given load, a higher pressure in the tire 116 results in a smaller deformation and a smaller contact length 604 with the surface 600 on which the tire 116 is moving. Similarly, for a given pressure in the tire 116, a higher load results in a larger deformation and a larger contact length 604 with the surface 600 on which the tire 116 is moving.

In particular, the load on the tire 116 may be computed as the product of the area in contact with the road and the pressure. Accordingly, the server 104 may obtain the contact length determined at block 425 and compute the load on the tire 116 as the product of the contact length, a width of the tire 116, and the pressure obtained at block 805. The width of the tire 116 may be a predetermined measurement stored, for example in the memory 304 of the server 104 or may be received from the monitoring hub 124 as part of the vehicle data received at block 405.

At block 815, the server 104 determines whether the load computed at block 810 meets a hazard and/or risk condition for the tire 116. For example, if the load on the tire 116 exceeds a maximum recommended load, the server 104 may identify a risk condition associated with the load on the tire 116. In some examples, in addition to the load computed at block 810, the server 104 may obtain historical loads for the tire 116, for example over a predefined period (e.g., 1 day, 10 days, 1 month, etc.). The server 104 may then determine whether the current load (i.e., as determined at block 810), together with the historical load on the tire 116 constitute a risk condition. For example, if the load is above a threshold load (e.g., within a threshold percentage of the maximum recommended load for the tire 116), and the tire 116 has been subject to similar excessive loads for at least a threshold amount of the predefined period (e.g., a threshold percentage of the predefined period, a threshold number of times over the predefined period, etc.), then the server 104 may determine that a risk condition has been met. If the tire 116 has not been subject to excessive loads over the predefined period, then the server 104 may determine that the tire 116 is not yet at a risk condition which should be noted. In other examples, other load risk conditions are also contemplated.

If, at block 815, the determination is affirmative, that is, the server 104 determines that a risk condition is met based on the load determined at block 810, then the server 104 proceeds to block 820. At block 820, the server 104 identifies a load risk for the tire 116. The server 104 may transmit a notification or an alert to an operator of the vehicle 112 to notify the operator of the load risk on the tire 116. For example, the notification may be an email notification, a text message, a push notification, or the like. In other examples, the server 104 may transmit the notification of the load risk to the monitoring hub 124, which may in turn provide the notification of the load risk to the operator (e.g., at the monitoring hub 124 itself, or by transmitting notification to a mobile device or the like for the operator). In some examples, the server 104 may handle the load risk according to the urgency of the identified risk. For example, if the load exceeds the maximum recommended load and hence may cause rapid and imminent failure of the tire 116, the server 104 may send an urgent alert notifying the operator and other parties as necessary. If the historical load indicate a long-term risk of faster than normal wear over the lifespan of the tire 116, then the server 104 may provide a simple notification, and/or may save the notification for inclusion in a periodic (e.g., daily, weekly, etc.) status report or the like.

After identifying the load risk at block 820, or if the server 104 determines at block 815 that no risk condition is detected based on the load, the server 104 proceeds to block 825.

At block 825, the server 104 obtains historical contact lengths for the tire 116. For example, the historical contact lengths for a given tire 116 may be stored in the memory 304, and more particularly, in the repository 316. In particular, contact length variation over time may be an indicator of excessive wear on a tire. In some examples, in order to compare contact lengths under similar conditions, the server 104 may retrieve contact lengths for the tire 116 when the tire 116 is under similar loads (e.g., within a threshold percentage) as computed at block 810.

At block 830, the server 104 determines whether the contact length for the tire 116, in view of the historical contact lengths for the tire 116, meets a hazard and/or risk condition for the tire 116. For example, if the contact length for the tire 116 has increased by a threshold percentage over a predefined period (e.g., 1 month, over the lifetime of the tire 116, etc.), the server 104 may determine a risk condition has been met. In other examples other contact length risk conditions are also contemplated.

If, at block 830, the determination is affirmative, that is, the server 104 determines that a risk condition is met based on the contact length and historical contact lengths for the tire 116, then the server 104 proceeds to block 835. At block 835, the server 104 identifies a contact length risk for the tire 116. The server 104 may transmit a notification or alert to an operator of the vehicle 112, or to the monitoring hub 124, which may in turn provide the notification to the operator.

After identifying the contact length risk at block 835, or if the server 104 determines at block 830 that no risk condition is detected based on the contact length, the server 104 proceeds to block 840.

At block 840, the server 104 obtains temperature data for the tire 116. The temperature data may be, for example, temperature data received as a part of the vehicle data at block 405 of the method 400. In particular, the temperature data represents the temperature of the tire 116. Further, since the temperature sensor 216 is arranged in the sensing arrangement to be adjacent to the inner side 200 of the tire 116, the temperature data is representative of the material forming the tire 116 itself, rather than the temperature of the air cavity of the tire 116. This is in contrast to typical temperature sensors which are disposed at the valve stem of the tire 116, as the operational range of temperature sensors at the valve stem does not capture the tire material, and accordingly, may vary from the temperatures experienced by the tire 116 itself.

At block 845, the server 104 determines whether the temperature experienced by the tire 116 meets a hazard and/or risk condition for the tire 116. For example, if the temperature of the tire 116 exceeds a threshold temperature (e.g., a critical temperature such as about 90° C. which the tire 116 should not exceed), the server 104 may identify a risk condition associated with the temperature of the tire 116. In some examples, in addition to the temperature obtained at block 840, the server 104 may obtain historical temperatures for the tire 116, for example over a predefined period. The server 104 may then determine whether the current temperature, together with the historical temperature of the tire constitute a risk condition. For example, increased maximum temperatures over time (i.e., based on a maximum temperature over a trip, as the tire 116 increases in temperature with movement), may indicate wear and potential failure of the tire 116. In other examples, rapid changes in temperature for a given trip (e.g., within a 1 minute or 5-minute span or the like) may also indicate an imminent risk condition. In other examples, other temperature risk conditions are also contemplated.

If, at block 845, the determination is affirmative, that is, the server 104 determines that a risk condition is met based on the temperature obtained at block 840, then the server 104 proceeds to block 850. At block 850, the server 104 identifies a temperature risk for the tire 116. The server 104 may transmit a notification or alert to an operator of the vehicle 112, or to the monitoring hub 124, which may in turn provide the notification to the operator.

After identifying the temperature risk at block 850, or if the server 104 determines at block 845 that no risk condition is detected based on temperature, the server 104 proceeds to block 855.

At block 855, the server 104 may aggregate the load, contact length and temperature performance factors to determine overall tire performance or working condition assessment. For example, if the server 104 determines that the tire data obtained at block 405 for the given tire 116 does not indicate any imminent or long-term risk conditions, then the server 104 may determine that the tire 116 is in working condition. In some examples, the server 104 may transmit a notification that the working condition of the tire 116 is in an acceptable state to an operator of the vehicle 112, or to the monitoring hub 124, which may in turn provide the notification to the operator. If one or more risk conditions were identified, then the working condition assessment may include an indication of the identified risks. In some examples, if the working condition assessment of the tire 116 includes an identification of one or more risk conditions as identified at blocks 820, 835, or 850, then in some examples, the notification or alerts may be transmitted as a single notification as part of the working condition assessment, rather than individually at blocks 820, 835, and 850. In further examples, the working condition assessment of the tire 116 may be stored for inclusion in a periodic status report for the vehicle or the like.

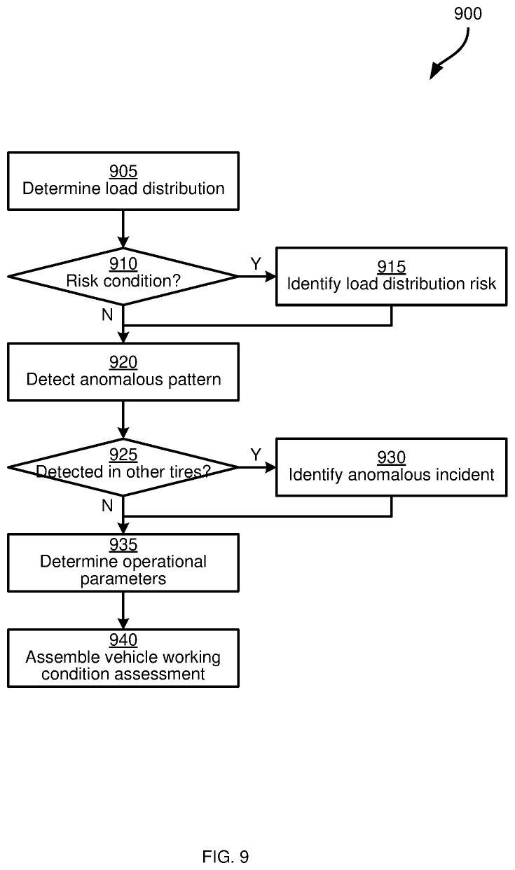

In addition to the single tire performance analysis, the server 104 may determine vehicle performance for the vehicle 112 as a whole. For example, referring to FIG. 9, a flowchart of an example method 900 of determining vehicle performance is depicted. In some examples, the operations of the method 900 may be performed in an order other than that depicted.

At block 905, the server 104 obtains the load applied to each of the tires 116, for example as determined at block 810 of the method 800. The server 104 may then determine an overall load for the vehicle 112, as well as a load distribution of the overall load on the tires 116. For example, the server 104 may express the load distribution for each tire 116 as a percentage of the overall load.

At block 910, the server 104 determines whether the load distribution on the tires 116 meets a hazard and/or risk condition for the vehicle 112. For example, if the load distribution is expected to be substantially equal between each of the tires 116, and the load distribution indicates an uneven distribution (e.g., more than a threshold percentage differential between respective load distributions of each tire 116), then the server 104 may identify a load distribution risk condition. Preferably, the thresholds may be tuned to account for differences in load distribution for a different number of passengers (e.g., four adults vs. one adult in the driver's seat) or other day-to-day variable factors. Accordingly, in some examples, the thresholds for load distribution differences may vary according to the overall load on the vehicle 112.

In other examples, the load distribution amongst the tires 116 may be expected to be different. For example, when the vehicle is a semi-trailer, the server 104 may expect that the trailer-bearing tires 116 may have a higher load relative to the cab-bearing tires 116. The difference in tires 116 may be predetermined and stored for example in the memory 304 or the like. In such examples, the server 104 may additionally store an expected or ideal load distribution. Accordingly, the server 104 may compare the load distribution determined at block 905 to the expected or ideal load distribution. If the load distribution varies by more than a threshold percentage from the expected or ideal load distribution, the server 104 may identify a load distribution risk condition at block 910.

Further, in some examples, the server 104 may obtain historical load distribution for the vehicle 112 over a predefined period, such as based on a current trip of the vehicle 112. In particular, a differing load distribution over a single trip may indicate a shifting load within the vehicle, which may indicate unsecured loads or unsafe conditions, for example due to tipping risks of large vehicles when turning. In other examples, other load distribution risk conditions are also contemplated.

If, at block 910, the determination is affirmative, that is, the server 104 determines that a risk condition is met based on the load distribution determined at block 905, then the server 104 proceeds to block 915. At block 915, the server 104 identifies a load distribution risk for the vehicle 112. The server 104 may transmit a notification or alert to an operator of the vehicle 112, or to the monitoring hub 124, which may in turn provide the notification to the operator.

After identifying the load distribution risk at block 915, or if the server 104 determines at block 910 that no risk condition is detected based on load distribution, the server 104 proceeds to block 920.

At block 920, the server 104 checks the deformation data for each of the tires 116 for any anomalous patterns. An anomalous pattern is a pattern (e.g., a pulse or other shift) away from the baseline, and which does not conform to the repeating pattern (e.g., based on magnitude and width, or the like). For example, the server 104 may identify the pulse 704-2 as depicted in FIG. 7 as an anomalous pattern.

At block 925, the server 104 determines whether the anomalous pattern (or a similar anomalous pattern) is also detected in the other tires 116 of the corresponding vehicle 112. That is, the server 104 may check for an analogous anomalous pattern in the deformation data of each of the other tires 116. For example, a pattern may be determined to be analogous if has similar proportions (e.g., magnitude and/or width) and/or if it occurs within a threshold time of the anomalous pattern (e.g., within 1 second, etc.).

In particular, if at least one of the other tires 116 has deformation data with an analogous anomalous pattern, then the server 104 may assume that an external event has occurred. For example, if the vehicle 112 traverses a pothole (or other bump, imperfection, or defect in the surface on which the vehicle 112 is travelling), the tires 116 may deform in a different manner from the repeating pulse 630. Since the tires 116 are situated at different locations on the vehicle 112, each tire 116 may experience a different anomalous deformation. For example, corresponding front and rear tires 116 traversing the defect may detect the anomalous deformation at offset times (e.g., offset by half a second). In some examples, if the defect is sufficiently small, the tires 116 on the opposing side of the vehicle 112 may experience little to no anomalous deformation, and accordingly, an analogous anomalous pattern may not be detected in the deformation data for the opposing tires 116. In other examples, the defect may be sufficiently large such that the tires 116 on the opposing side of the vehicle 112 do experience an anomalous deformation. However, the opposing tires 116 may deform differently based on their distance from the defect. Accordingly, the anomalous pattern may not be proportional, but may still occur within the threshold time of the anomalous pattern.

In such examples, the server 104 may determine that the anomaly in the deformation data was likely caused due to an external event or surface defect which affected each of the tires 116, rather than a simultaneous failure or other internal incident of each of the tires 116. Accordingly, if the determination at block 925 is affirmative, the server 104 may proceed to block 935. In some examples, the server 104 may note the anomalous pattern and a time of occurrence for comparison of tire data for each of the tires 116, for example to determine whether the external event affected the integrity and/or performance of any of the tires 116.

If an analogous anomalous pattern is not detected in any of the other tires 116 of the corresponding vehicle 112, then the server 104 proceeds to block 930. At block 930, the server 104 identifies an anomalous event for the given tire 116 having the anomalous pattern. In some examples, the server 104 may note the anomalous pattern and a time of occurrence for comparison of the tire data for the given tire 116 to determine whether the anomalous event affected the integrity and/or performance of the given tire 116.

At block 930, the server 104 may additionally transmit a notification or alert to an operator of the vehicle 112, or to the monitoring hub 124, which in turn may provide the notification to the operator. For example, the notification may include a prompt to manually inspect the tire 116 experiencing the anomalous event (e.g., to check for nails or sharp objects impaling the tire 116 or the like). In some examples, the notification provided to the operator may depend on the severity (e.g., magnitude and width) of the anomalous event.

At block 935, the server 104 may additionally determine other operational parameters of the vehicle 112. For example, since a peak in the deformation data occurs each time the deformation sensor 212 passes through the contact length 604, the frequency of the peaks corresponds to the speed at which the tire 116 is rotating. Accordingly, based on the frequency of the peaks and the radius of the tire 116, the server 104 may determine a rotation speed of the tires 116, and hence of the vehicle 112. Further, the server 104 may determine an acceleration of the tires 116 (and hence of the vehicle 112) based on a change in frequency of peaks (i.e., the repeating pattern) in the deformation data.

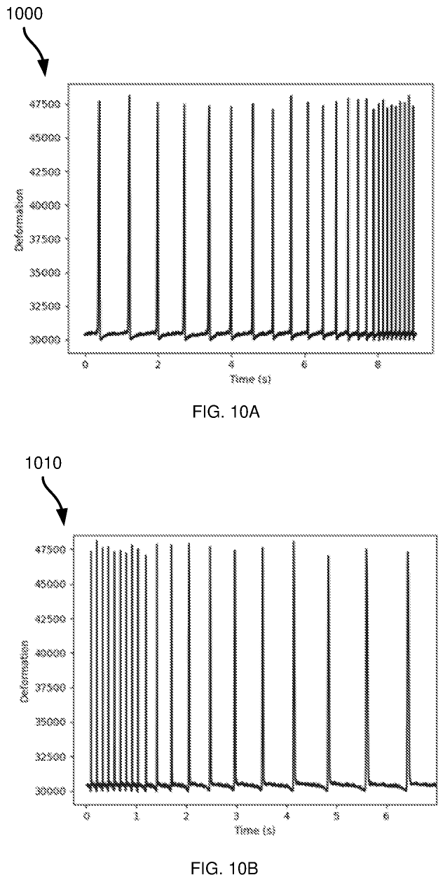

For example, referring to FIGS. 10A and 10B, a first example plot 1000 depicts deformation data when the vehicle 112 is accelerating, while a second example plot 1010 depicts deformation data when the vehicle 112 is decelerating.

Returning again to FIG. 9, at block 940, the server 104 may assemble a vehicle performance or working condition assessment. In particular, the server 104 may aggregate the load distribution, pattern analysis, and operational parameter factors for the vehicle.

For example, if the server 104 determines that the vehicle data obtained at block 405 does not indicate any imminent or long-term risk conditions, the server 104 may determine that the vehicle 112 is in an acceptable working condition. The server 104 may transmit a notification of the acceptable working condition to an operator of the vehicle 112, or to the monitoring hub 124, which may in turn provide the notification to the operator. If one or more risk conditions were identified, then the working condition assessment may include an indication of the identified risks. In some examples, the risks may be identified as part of the working condition assessment at block 940, rather than individually at blocks 915 and 930. Further in some examples, the tire working condition assessments for each of the tires (i.e., as obtained at block 855 of the method 800) may be aggregated and identified as part of the vehicle working condition assessment at block 940, rather than individually.

The vehicle working condition assessment may be transposed to a periodic status report for the vehicle which may be transmitted to the operator of the vehicle and/or the monitoring hub 124 periodically.

As will be appreciated, variations to the above-described systems and methods are also possible. For example, some or all of the analysis described above as being performed by the server 104 may be performed by the monitoring hub 124 locally, to provide data including when communication between the monitoring hub 124 and the server 104 is interrupted. For example, the operational parameters, such as vehicle speed, acceleration and deceleration may be computed by the monitoring hub 124 for feedback to an operator of the vehicle 112. In still further examples, some or all of the analysis described above may be performed by the processor 230 of the sensing arrangement 120.

Further, in some examples, the tire data for each for each of the tires may be annotated and added to a training set to train a machine-learning based model, for example to identify other potential risks for individual tires or for the vehicle based on trends and correlations between the deformation data, the temperature data, and the pressure data. For example, after detecting anomalous events, both affecting a single tire and affecting more than one tire, the deformation data for each of the tires may be annotated with the type of anomalous event experienced (e.g., speed bump, pothole, nail in tire, etc.) to allow a trained model to predict the type of anomalous event based on the deformation data. The tire data may additionally be used to develop models for tire wear, to predict tire failure, to optimize fuel efficiency, and the like. Such information may be used, for example to manage a fleet of vehicles, to manage tire changes in performance racing, inform tire design, and other applications.

In some examples, the tire data may be supplied to an autonomous vehicle decision module, to better inform autonomous vehicle systems of road conditions as detected by the tires. For example, such tire data may be indicative of ice on the road, or similar, which may affect driving speeds, acceleration, braking, steering, and other vehicle parameters selected by the autonomous vehicle system.

The scope of the claims should not be limited by the embodiments set forth in the above examples but should be given the broadest interpretation consistent with the description as a whole.

1. A sensing arrangement for a tire, the sensing arrangement comprising:
a substrate configured to couple the sensing arrangement to an inner side of the tire;
a deformation sensor supported by the substrate and configured to collect deformation data representing deformation at the inner side of the tire; and
a control module configured to transmit the deformation data collected by the deformation sensor to a recipient device.

2. The sensing arrangement of claim 1, wherein the deformation sensor is configured to:
detect a first deformation shift at an entry point of a contact length of the tire with a surface;
detect a deformation peak over the contact length of the tire with the surface; and
detect a second deformation shift at an exit point of the contact length of the tire with the surface.

3. The sensing arrangement of claim 1, further comprising one or more of:
a temperature sensor supported by the substrate adjacent to the inner side of the tire, the temperature sensor configured to measure a temperature at the inner side of the tire; and
a pressure sensor supported by the substrate, the pressure sensor configured to measure a pressure within the tire.

4. (canceled)

5. (canceled)

6. (canceled)

7. The sensing arrangement of claim 1, wherein the deformation sensor has a length exceeding a length of a tread pattern of the tire.

8. The sensing arrangement of claim 1, further comprising a vibration damping portion configured to isolate the control module from vibrations experienced by the substrate.

9. A tire monitoring system for monitoring a set of tires of a vehicle, the system comprising:
a set of sensing arrangements, each sensing arrangement configured to couple to an inner side of one of the tires in the set to collect deformation data representing deformation at the inner side of the tire; and
a monitoring hub configured to aggregate the deformation data from each sensing arrangement in the set and transmit the aggregated deformation data to a server.

10. A server comprising:
a memory;
a communications interface; and
a processor interconnected with the memory and the communications interface, the processor configured to:
obtain deformation data representing deformation of a tire over a series of rotations;
detect a repeating pattern in the deformation data;
determine, based on the repeating pattern, a contact angle of the tire;
determine a contact length as a product of the contact angle and a radius of the tire; and
determine a working condition assessment of the tire based on the contact length.

11. The server of claim 10, wherein to determine the contact angle, the processor is configured to:
determine a contact time based on a width of an instance of the repeating pattern;
determine a revolution time based on a distance between the instance of the repeating pattern and a subsequent instance of the repeating pattern; and
compute the contact angle based on a ratio of the contact time to the revolution time.

12. The server of claim 11, wherein the processor is configured to determine the width of the instance of the repeating pattern based on a full-width-half-maximum distance of the instance of the repeating pattern.

13. (canceled)

14. The server of claim 10, wherein the processor is further configured to determine one or more of:
a rotation speed of the tire based on a frequency of the repeating pattern in the deformation data; and
an acceleration of the tire based on a change in frequency of the repeating pattern in the deformation data.

15. (canceled)

16. The server of claim 10, wherein the processor is further configured to:
obtain further deformation data for a set of tires of a vehicle, the set of tires including the tire;
detect an anomalous pattern in the deformation data; and
when no analogous anomalous pattern is detected in the further deformation data, identify an anomalous event for the tire.

17. The server of claim 10, wherein the processor is further configured to:
obtain pressure data representing an internal tire pressure; and
determine a load on the tire based on the contact length and the pressure data.

18. The server of claim 17, wherein the processor is further configured to:
obtain further deformation data and further pressure data for a set of tires of a vehicle, the set of tires including the tire; and
determine a load distribution between the tires in the set.

19. A method of monitoring a tire, the method comprising:
obtaining deformation data representing deformation of the tire over a series of rotations;
detecting a repeating pattern in the deformation data;
determining, based on the repeating pattern, a contact angle of the tire;
determining a contact length as a product of the contact angle and a radius of the tire; and
determining a working condition assessment of the tire based on the contact length.

20. The method of claim 19, wherein determining the contact angle comprises:
determining a contact time based on a width of an instance of the repeating pattern;
determining a revolution time based on a distance between the instance of the repeating pattern and a subsequent instance of the repeating pattern; and
computing the contact angle based on a ratio of the contact time to the revolution time.

21. The method of claim 20, wherein determining the width of the instance of the repeating pattern based on a full-width-half-maximum distance of the instance of the repeating pattern.

22. (canceled)

23. The method of claim 19, further comprising determining one or more of:
a rotation speed of the tire based on a frequency of the repeating pattern in the deformation data; and
an acceleration of the tire based on a change in frequency of the repeating pattern in the deformation data.

24. (canceled)

25. The method of claim 19, further comprising:
obtaining further deformation data for a set of tires of a vehicle, the set of tires including the tire;
detecting an anomalous pattern in the deformation data; and
when no analogous anomalous pattern is detected in the further deformation data, identifying an anomalous event for the tire.

26. The method of claim 19, further comprising:
obtaining pressure data representing an internal tire pressure; and
determining a load on the tire based on the contact length and the pressure data.

27. The method of claim 26, further comprising:
obtaining further deformation data and further pressure data for a set of tires of a vehicle, the set of tires including the tire; and
determining a load distribution between the tires in the set.
